(19) United States
(12) Patent Application Publication
(10) Pub. No.: US 2012/0041610 A1
(43) Pub. Date: Feb. 16, 2012

(54) CONTROLLER FOR COMBINED HEAT AND POWER SYSTEM

(75) Inventors: Subbarao Varigonda, Manchester, CT (US); Lars M. Pedersen, Wethersfield, CT (US); Stevo Mijanovic, South Windsor, CT (US); Michael G. O'Callaghan, West Palm Beach, FL (US); Vivek Halwan, South Windsor, CT (US); Mihai Huzmezan, White Rock (CA)

(73) Assignee: CARRIER CORPORATION, Farmington, CT (US)

(21) Appl. No.: 13/266,204

(22) PCT Filed: Apr. 20, 2010
(86) PCT No.: PCT/US10/31711

§ 371 Date: Oct. 25, 2011

Related U.S. Application Data
(60) Provisional application No. 61/173,792, filed on Apr. 29, 2009.

(51) Int. Cl. F02C 6/18

(52) U.S. Cl. 700/288

(57) ABSTRACT

A controller for controlling a combined heat and power (CHP) system which can include one or more CHP units, can comprise a high level optimizer and one or more low level optimizers. The high level optimizer can be configured to optimize a total cost of producing heating, cooling, and electric power, by allocating total heating, cooling, and/or electric power setpoints one or more CHP unit types, based on the fuel price, CHP unit operational constraints, and/or heating, cooling, and/or electric power demand. The low level optimizer can be configured to allocate cooling, heating, and/or electric power setpoints to individual CHP units, based on the high level allocation to CHP unit types.

### CROSS REFERENCE TO RELATED APPLICATION

This application claims priority to U.S. Provisional Patent Application Ser. No. 61/173,792 entitled “Controller for Combined Heat and Power System” filed on Apr. 29, 2009. The content of this application is incorporated herein by reference in its entirety.

### GOVERNMENT CONTRACT

The disclosure described herein was made during the course of or in the performance of work under U.S. Government Contract No. 4000009518(17) awarded by the Department of Energy.

### FIELD OF THE DISCLOSURE

This disclosure is related generally to power conversion systems, and more specifically to a controller for controlling a combined heat and power system to optimize energy production costs.

### BACKGROUND OF THE DISCLOSURE

Combined heat and power (CHP) systems are widely employed to provide facility electricity, heating and cooling for commercial, industrial or residential sites. A typical CHP system produces heat by combusting fuel, then transforms the heat into mechanical power using, e.g., a turbine, and finally transforms the mechanical power into electric power using, e.g., a generator. The thermal energy in the exhaust from the turbine is used to provide useful heating thermal output. A CHP system can also include an absorption chiller to produce cooling thermal output. Examples include a fuel cell power plant for producing electricity and useful heating thermal output, and an absorption chiller hybrid for producing electricity and useful cooling or heating power output.

Proper coordination of different types of CHP systems is required during operation to realize projected benefits in operating costs. Conventional modes of operation, such as load following, peak shaving, and base loading may not achieve full savings in markets with large price variability. It is often difficult for a human operator to choose the correct mode of operation and/or correct operational parameters. Thus, a need exists to provide means and methods of automatically controlling a CHP system to optimize the energy production costs.

### SUMMARY

There is provided a controller for controlling a combined heat and power (CHP) system, which can include one or more CHP units. Each CHP unit can be characterized by a CHP unit type, and can be configured to generate heating, cooling and/or electric power. The controller according to the present invention can comprise a high level optimizer and one or more low level optimizers.

The high level optimizer can be configured to optimize a total cost of producing heating, cooling, and electric power, by allocating total heating, cooling, and/or electric power setpoints to at least one CHP unit type, based on the fuel price, CHP unit operational constraints, and/or heating, cooling, and/or electric power demand.

The low level optimizer can be configured to allocate cooling, heating, and/or electric power setpoints to individual CHP units, based on the high level allocation to CHP unit types.

### BRIEF DESCRIPTION OF THE DRAWINGS

FIG. 1 illustrates an example of hierarchical architecture of a CHP system controller according to the present disclosure.

FIG. 2 illustrates a component view of one embodiment of a CHP unit.

FIG. 3 illustrates input/output views of several CHP unit types.

FIG. 4 illustrates an example of a method of load distribution among individual CHP units implemented by a low level optimizer according to the present disclosure.

The drawings are not necessarily to scale, emphasis instead generally being placed upon illustrating the principles of the present invention. In the drawings, like numerals are used to indicate like parts throughout the various views.

### DETAILED DESCRIPTION OF THE DISCLOSURE

There is provided a controller for controlling a combined heat and power (CHP) system. The CHP system can combust fuel and produce useful electric power output, as well as useful heating and/or cooling power output.

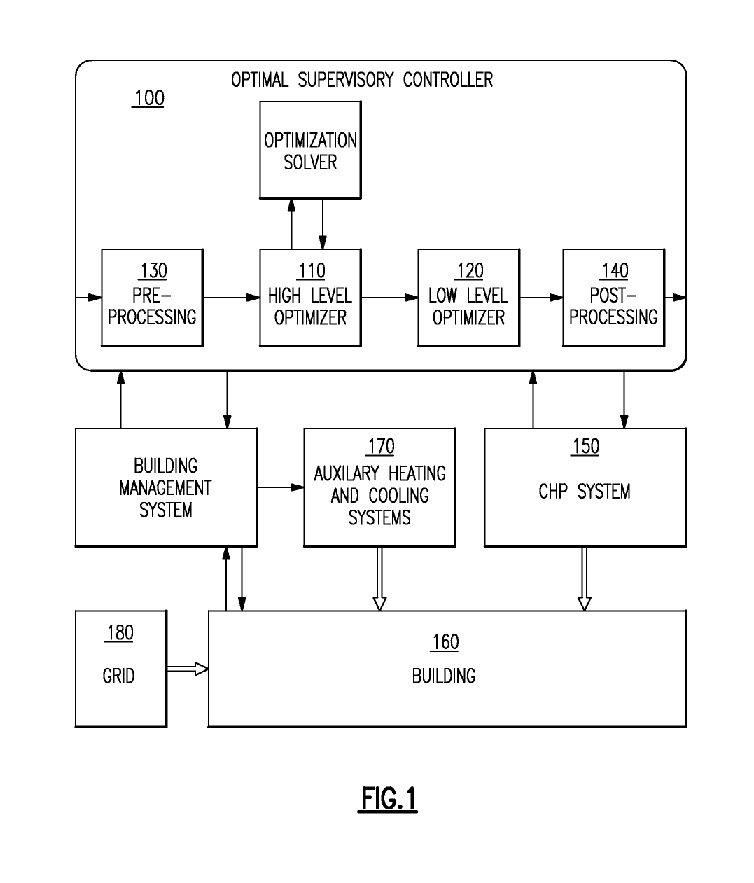

In one aspect, the controller 100 according to the present disclosure can have a hierarchical architecture comprising a high level optimizer 110 and one or more low level optimizers 120, as best viewed in FIG. 1. The high level optimizer 110 can optimize the total cost of producing useful energy outputs, including heating, cooling, and electric energy. The low level optimizer 120 can distribute the load among individual CHP units.

In one embodiment, the CHP system 150 controlled by the controller 100, can be employed to satisfy the demands of the consumer 160 (e.g., a commercial, industrial or residential building) in heating, cooling, and/or electric power. The demand levels can be pre-determined, or can vary, e.g., depending on the time of day.

In another aspect, an auxiliary heating and/or cooling system can be provided at the consumer site. In a further aspect, the consumer site can be connected to an electric grid 180 and be able to import electricity from the grid when it is economically favorable or in order to satisfy the demand for electricity which can not be satisfied by the CHP system 150 (e.g., a peak demand).

In one embodiment, the pre-processing block 130 can compute the demand levels for electric and thermal power and output the computed demand levels to the high level optimizer 110. In another aspect the pre-processing block 130 can supply to the high level optimizer 110 other information necessary for controller functioning, including, e.g., grid electricity pricing information.

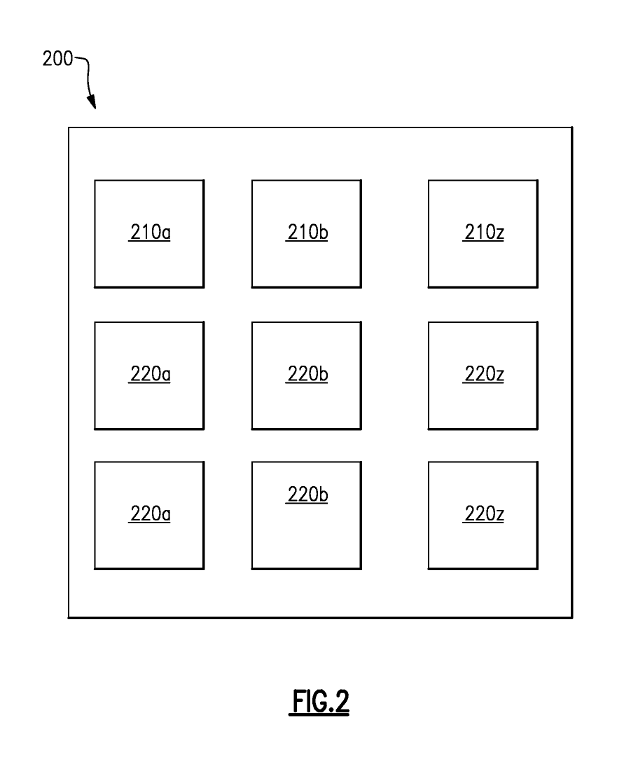

In one embodiment, the CHP system 150 can include one or more CHP units. In one embodiment, a CHP unit 200 can include, as best viewed in FIG. 2, one or more electricity sources 210a-210z (e.g., a gas turbine or a steam generator), one or more heating sources 220a-220z (e.g., a boiler), and/or one or more cooling sources 230a-230z (e.g., an absorption chiller).

In another aspect, the CHP system 150 of FIG. 1 can include one or more CHP units of different CHP unit types. In one embodiment, the CHP system can include one or more PureComfort® CHP units, one or more PureComfort Trigen® CHP units, and one or more PureThermal® CHP units.

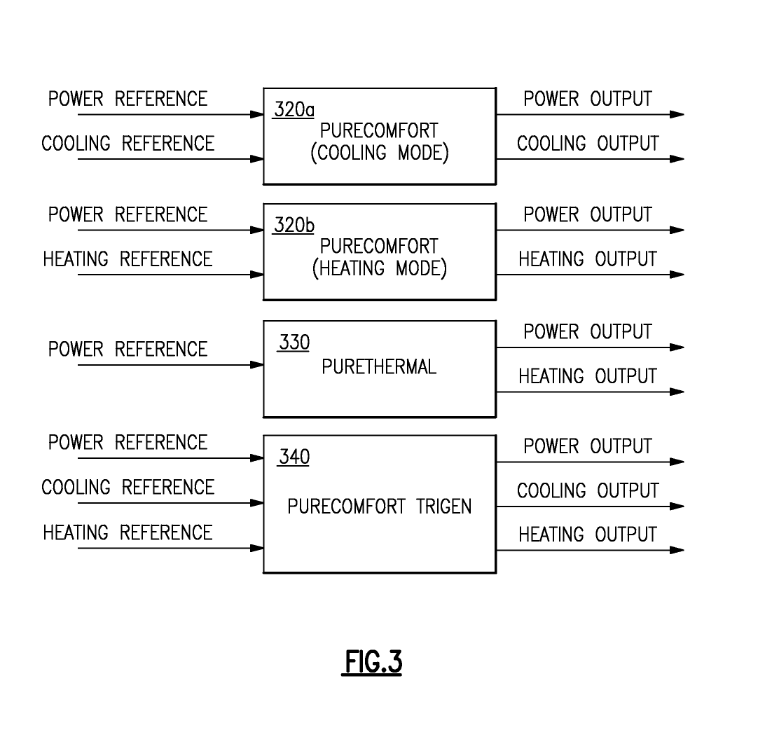

FIG. 3 illustrates models of several CHP unit types showing the input and output signals reflecting the basic functionality. A PureComfort® CHP unit is a microturbine-absorption chiller hybrid producing electricity and useful cooling or heating power output, which can be configured to operate in cooling mode 320a or heating mode 320b. A PureComfort Trigen® CHP unit 340 can produce electricity and cooling and heating thermal outputs. A PureThermal® CHP unit 330 can produce electricity and useful heating thermal output. A skilled artisan would appreciate the fact that other types of CHP units are within the scope and the spirit of the invention.

The cost of energy production by a CHP system can depend on a number of variables, including the price of fuel, the price of electricity imported from a grid, and operational characteristics of CHP units.

In one embodiment, the total cost of producing useful energy output can be calculated as follows:

$$Cost ( \frac{\$}{hour} ) = \frac{F P}{{Eta}_{MT}} \cdot {P}_{PC} + \frac{FP}{{Eta}_{MT}} \cdot {p}_{PCh} + \frac{FP}{{Eta}_{MT}} \cdot {P}_{PCT} ++ \frac{FP}{{Eta}_{MT}} \cdot {P}_{PCTh} + \frac{FP}{{Eta}_{MT}} \cdot {P}_{PT} + \frac{FP\_Aux}{{Eta}_{aux\_boiler}} \cdot {H}_{aux} + EP \cdot {P}_{grid} \qquad ( 1 )$$

wherein FP is the fuel price,

Etaₘₜ is the net electrical efficiency of the microturbine;

P_{PC} is the electric power output of the PureComfort® CHP units;

P_{PCH} is net electric power output of the PureComfort® CHP unit configured in heating mode;

P_{PCT} is the net electric power output of the PureComfort Trigen® CHP units;

P_{PCTH} is net electric power output of the PureComfort Trigen® CHP unit configured in heating mode;

P_{PT} is the electric power output of the PureThermal® CHP units;

FP_Aux is the fuel price for the auxiliary heater (one or more heating sources defined as being external to CHP system considered, such as a boiler);

Hₐᵤₓ is the heating power output from the auxiliary heaters (a heating source defined as being external to CHP system considered, such as a boiler);

Etaₐᵤₓ_{_{—}}_{boiler} is the efficiency of the auxiliary heater;

EP is the price of electricity imported from grid ($/kWh);

P_{grid} is the amount of electricity imported from grid.

In another aspect, an operating envelope for each of the CHP unit types can be described by a set of inequality and/or equality constraints in the C, H, P space, where C is the cooling power output, H is the heating power output, and P is the electric power output of the CHP unit. For example, an operating envelope for a PureComfort® CHP unit can be described by the following set of linear inequality constraints in the cooling mode (2) and the heating mode (3) of operation:

P_{PC}+α₁C_{PC}≦α₂ (2)

P_{PCh}+α₁ₕH_{PCh}≦α₂ₕ (3)

wherein α₁ is a pre-determined constant value derived from experiments or from equipment specifications;
α₂ is a pre-determined constant value derived from experiments or from equipment specifications;
α₁ₕ is a pre-determined constant value derived from experiments or from equipment specifications;
α₂ₕ is a pre-determined constant value derived from experiments or from equipment specifications;
C_{PC} is the cooling power output by a PureComfort® CHP unit; and
H_{PCh} is the heating power output by a PureComfort® CHP unit.

An operating envelope for a PureComfort Trigen® CHP unit can be described by the following set of linear inequality constraints in the cooling mode (4)-(5) and the heating mode (6) of operation:

P_{PCT}+β₁C_{PCT}+β₂H_{PCT}≦β₃

β₄C_{PCT}+H_{PCT}≦β₅ (4)-(5)

wherein

β₁ is a pre-determined constant value derived from experiments or from equipment specifications;
β₂ is a pre-determined constant value derived from experiments or from equipment specifications;
H_{PCT} is the heating power output from the PureComfort Trigen® CHP unit;
β₃ is a pre-determined constant value derived from experiments or from equipment specifications;
β₄ is a pre-determined constant value derived from experiments or from equipment specifications;
β₅ is a pre-determined constant value derived from experiments or from equipment specifications;

P_{PCTh}+β₁ₕ_{_{—}}_{PCT}H_{PCTh}≦β₂ₕ_{_{—}}_{PCT} (6)

wherein

β₁ₕ_{_{—}}_{PCT} is a pre-determined constant value derived from experiments or from equipment specifications;
H_{PCTh} is the heating power output by PureComfort Trigen® CHP unit configured in heating-only mode; and
β₂ₕ_{_{—}}_{PCT} is a pre-determined constant value derived from experiments or from equipment specifications;

An operating envelope for a PureThermal® CHP unit can be described by the following linear equality constraint:

P_{PT}+γ₁_{_{—}}_{PT}H_{PT}=γ₂_{_{—}}_{PT} (7)

wherein

γ₁_{_{—}}_{PT} is a pre-determined constant value derived from experiments or from equipment specifications;
H_{PT} is the heating power output by a PureThermal® CHPunit; and
γ₂_{_{—}}_{PT} is a pre-determined constant value derived from experiments or from equipment specifications;

In a further aspect, the high level optimizer can include additional equality constraints reflecting the matching of power supply to power demand:

$${P}_{PC} + {P}_{PCh} + {P}_{PCT} + {P}_{PCTh} + {P}_{PT} + {P}_{grid} = {P}_{load} + \frac{1}{COP\_aux \_chiller} \cdot {C}_{aux} \\ {C}_{PC} + {C}_{PCT} + {C}_{aux} = {C}_{load} \\ {H}_{PCh} + {H}_{PCT} + {H}_{PCTh} + {H}_{PT} + {H}_{aux} = {H}_{load} \qquad ( 8 ) \text{-} ( 10 )$$

wherein

P_{load} is the electric power demand to be satisfied by the CHP system;

C_{load} is the cooling power demand to be satisfied by the CHP system;

H_{load} is the heating power demand to be satisfied by the CHP system;

COP_aux_chiller is the “coefficient of performance” (ratio of cooling power output to electrical power input) of the auxiliary chiller;

Cₐᵤₓ is the cooling power output of the auxiliary chiller (one or more chillers defined to be external to the CHP system being considered, such as an electrical chiller);

In a further aspect, the cost function can further include additional decision variables reflecting electricity demand charges which can be modeled based on the maximum power consumption in a predetermined period of time (e.g., a month), as well as the maximum power consumption during the peak, part-peak, and off-peak periods. Hence, the cost function can be defined as follows:

$$Cost ( \frac{\$}{hour} ) = \frac{FP}{{eta}_{MT}} \cdot {P}_{PC} + \frac{FP}{{eta}_{MT}} \cdot {P}_{PCh} + \frac{FP}{{eta}_{MT}} \cdot {P}_{PCT} ++ \frac{FP}{{eta}_{MT}} \cdot {P}_{PCTh} + \frac{FP}{{eta}_{MT}} \cdot {P}_{PT} + \frac{FP\_Aux}{{eta}_{aux\_boiler}} \cdot {H}_{aux} + EP \cdot {P}_{grid} ++ EP\_Dem \cdot delta\_Pmax \_dem ++ EP\_Dem \_period \cdot delta\_Pmax \_dem \_period \qquad ( 11 )$$

wherein

EP_Dem is the electricity demand price over a billing period such as a month, $/kW; delta_Pmax_dem is the change in the maximum power drawn from the grid over the current billing cycle computed by the high-level optimizer at each sampling time; EP_Dem_period is the electricity demand price applicable to “period” (where period represents peak, part-peak or off-peak intervals of a day) within the current billing period, $/kW;
Delta_Pmax_dem_period is the change in the maximum power drawn from the grid in “period” (where period represents peak, part-peak or off-peak intervals of a day) within the current billing cycle computed by the high-level optimizer at each sampling time;

The additional inequality constraints to reflect electricity demand charges can include:

delta_{—}Pmax_{—}dem≧0

delta_{—}Pmax_{—}dem_period≧0

P_{grid}−delta_{—}Pmax_{—}dem≦P_max

P_{grid}−delta_{—}Pmax_{—}dem_period≦P_period (12)-(15)

wherein

P_max is the maximum power drawn from the grid over the current billing period;
P_period is the maximum power drawn from the grid during “period” (where period represents peak, off-peak or part-peak intervals of a day) within the current billing period;

Thus, in one embodiment, the high level optimizer can optimize the total cost of producing heating, cooling, and/or electric power, by allocating heating, cooling, and/or electric power setpoints to one or more CHP unit types, based on one or more of the following inputs: fuel price, power output demands for heating, cooling, and/or electric power, operational constraints for one or more of CHP unit types, price of electric power imported from the grid, and electricity demand charges. In a further aspect, the high level optimizer can perform the optimization at least once in a control interval which can be a pre-determined period of time (e.g., one hour). A skilled artisan would appreciate the fact that other control interval values, as well as performing the high level optimization responsive to an event, are within the scope and the spirit of the present invention.

In a further aspect, the cost function and the constraints can be linear, affine or nonlinear, and thus the high level optimizer can optimize the cost function using linear or nonlinear programming methods known in the art, e.g., an interior point method described in the book, Convex Optimization, by Stephen Boyd (Cambridge University Press, 2004, ISBN: 0521833787).

In another aspect, a low level optimizer can receive from the high level optimizer the electric power, cooling, and/or heating setpoints for one or more CHP unit types (e.g., PureComfort®, PureConfort Trigen®, and PureThermal®), and distribute the load among individual CHP units within each CHP unit type. The low level optimizer can further provide run-time balancing where-in the difference between the run-times of various microturbines over a long enough period (eg, quarters to years) is minimized by prioritizing what units can be turned off or on next, ensuring the minimum on-time and off-time constraints for various units (to ensure that the inefficiency during startup & shutdown does not negate the cost savings anticipated from the optimal supervisory control strategy), and minimizing the risk of power export to grid due to load changes between the sampling instances of the high level optimizer in situations where power export to the grid is not permitted. This constraint, for example, can be handled by maintaining a margin in the power drawn from the grid and by having a hardware protection in place for redundancy.

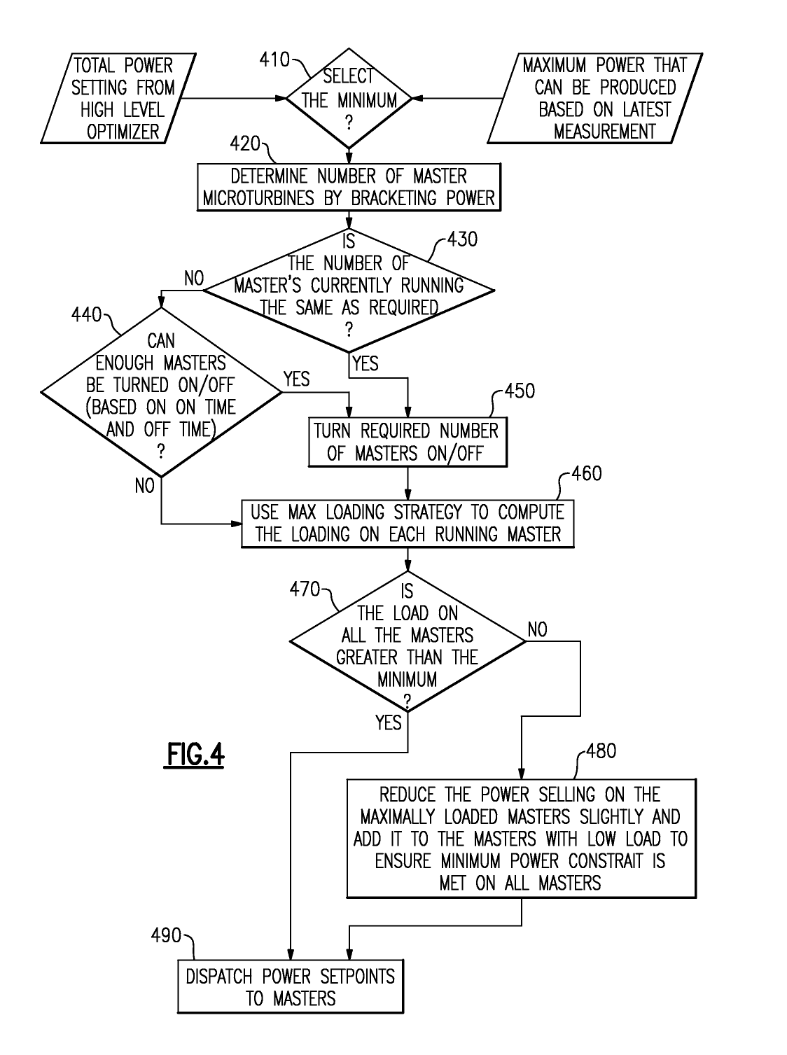

In a further aspect, the electric, heating and cooling setpoints can be treated independently by the low level optimizer. The load allocation by the low level optimizer can be characterized by one or more scheduling rules which can be implemented, e.g., as a decision tree an example of which is presented in FIG. 4. In one embodiment, the scheduling rules can be determined off-line, thus significantly reducing the requirements to the processing power of the low level optimizer.

FIG. 4 illustrates an example of a method of load distribution among individual CHP units implemented by a low level optimizer.

At step 410, the method selects the minimum among the sum of power setpoints received from the high level optimizer and the maximum power that can be produced by the CHP system. The latter can be determined by the equipment level controller or the calculation can be performed within the lower level optimizer using equipment performance data from suppliers & other site specific information and online measurements such as the altitude and ambient temperature. Although the high level optimizer takes into account the maximum limits on each class of CHP equipment, this is an example of additional and redundant protection that can be implemented in the lower level optimizer The processing continues at step 420.

At step 420, the method determined the number of master microturbines by bracketing power, that is, by identifying the minimum number of microturbines needed to produce the required power. The processing continues at step 430.

At step 430, the method ascertains whether the number of running master microturbines is equal to the required number computed in step 420 above and if so, the processing continues at step 460; otherwise the method branches to step 440.

At step 440, the method ascertains whether the required number of master microturbines can be turned on or off, based on on-time and off-time constraints for an individual microturbine, and if so, the processing continues at step 450; otherwise, the method branches to step 460.

At step 450, the low level optimizer turns the required number of master microturbines on or off. The processing continues at step 460.

At step 460, the load of each running microturbine is computed, e.g., by using an optimal loading strategy within the pack, which can be, for example, an “even loading” of all the microturbines or “staging or max-loading” where all but one of the microturbines run at or close to full-power. The processing continues at step 470.

At step 470, the method ascertains that the load on all running master microturbines is greater than a predetermined minimum load value, and if so, the method branches to step 490; otherwise, the processing continues at step 480.

At step 480, the low level optimizer reduces the power setpoint for maximally loaded master microturbines by a predetermined value, and adds the predetermined value to the master microturbines with low load, in order to ensure that the minimum power constraint is satisfied on all master microturbines. The processing continues at step 490.

At step 490, the low level optimizer dispatches the computed power setpoints to individual CHP units, and the method terminates.

In another aspect, the low level optimizer 120 of FIG. 1 can perform computing the power setpoints to individual CHP units responsive to receiving setpoints per CHP unit types from the high level optimizer. A skilled artisan would appreciate the fact performing the low level optimization responsive to other events, including a predetermined timeout expiration, is within the scope and the spirit of the present invention.

In another aspect, the post-processing block 140 of FIG. 1 can transform the setpoints outputted by the low level optimizer into a format suitable to be supplied to the actual CHP units.

We claim:

1. A controller for controlling a combined heat and power (CHP) system, said system including one or more CHP units, each CHP unit characterized by a CHP unit type, each CHP unit configured to generate at least one of: a heating output, a cooling output, and an electric power output, said controller comprising:
a high level optimizer configured to optimize a total cost of producing said heating outputs, said cooling outputs, and said electric power outputs, by allocating at least one of: a total electric power setpoint, a total cooling power setpoint, and a total heating power setpoint to at least one CHP unit type, said allocating performed based on at least one of: a fuel price, an electric power demand, a cooling power demand, a heating power demand, and one or more operational constraints of said one or more CHP units; and
at least one low level optimizer configured to allocate at least one of: an individual electric power setpoint, an individual cooling power setpoint, and an individual heating power setpoint to at least one CHP unit of said at least one CHP unit type.

2. The controller of claim 1, wherein said at least one CHP equipment type is selected from the group consisting of: a turbine generator, an absorbtion cooler, a boiler, a heat recovery steam generator, an electric chiller.

3. The controller of claim 1, wherein said CHP system is further configured to import electric power from a power grid; and
wherein said allocating by said high level optimizer is performed based on at least one of: a fuel price, an electricity price, an electric power demand, a cooling power demand, a heating power demand, and one or more operational constraints of said CHP units.

4. The controller of claim 1, wherein said high level optimizer is configured to optimize said total cost for a next control interval.

5. The controller of claim 1, wherein said at least one low level optimizer is configured to allocate at least one of: an individual electric power setpoint, an individual cooling power setpoint, and an individual heating power setpoint to at least one CHP unit of said at least one CHP equipment type based on at least one off-line scheduling rule.

6. The controller of claim 1, wherein said total cost is represented by a linear function of one or more variables selected from the group consisting of: a fuel price, an electric power demand, a cooling power demand, and a heating power demand.

7. The controller of claim 1, wherein said one or more operational constraints are represented by one or more of inequality and/or equality constraints in a space defined by one or more variables selected from the group consisting of: a cooling power, a heating power, and an electric power.

8. The controller of claim 1, wherein said one or more operational constraints are represented by one or more of inequality and/or equality linear constraints in a space defined by one or more variables selected from the group consisting of: a cooling power, a heating power, and an electric power.

9. The controller of claim 1, wherein said at least one low level optimizer performs at least one function selected from the group consisting of: run-time balancing of two or more CHP units, ensuring a minimum on-time and a minimum off-time constraints of at least one CHP unit, and ensuring a minimum power constraint of at least one CHP unit.

10. The controller of claim 1, further comprising at least one of: a pre-processing module and a post-processing module;
wherein said pre-processing module is configured to compute at least one of: heating demand level, cooling demand level, and electric power demand level, and output said at least one computed demand level to said high level optimizer; and
wherein said post-processing module is configured to transform said at least one of: an individual electric power setpoint, an individual cooling power setpoint, and an individual heating power setpoint outputted by said low level optimizer into a format suitable to be supplied to said at least one CHP unit.
